(19) United States
(12) Patent Application Publication
(10) Pub. No.: US 2024/0073920 A1
(43) Pub. Date: Feb. 29, 2024

(54) PHYSICAL DOWNLINK CONTROL CHANNEL MONITORING FOR SMALL DATA TRANSMISSION PROCEDURE

(71) Applicant: Nokia Technologies Oy, Espoo (FI)

(72) Inventors: Samuli TURTINEN, Ii (FI); Sami HAKOLA, Kempele (FI); Jussi-Pekka KOSKINEN, Oulu (FI); Chunli WU, Beijing (CN)

(21) Appl. No.: 18/261,374

(22) PCT Filed: Jan. 14, 2021
(86) PCT No.: PCT/CN2021/071934

§ 371 Date: Jul. 13, 2023

(51) Int. Cl. H04W 72/232

(52) U.S. Cl. CPC H04W 72/232

(57) ABSTRACT

Embodiments of the present disclosure relate to devices, methods, apparatuses and computer readable storage media of resource configuration for transmission of DMRS. The method comprises receiving, from a second device, information associated with a set of resources for monitoring a control channel between the first device and the second device for a Small Data Transmission (SDT) procedure, between the first device and the second device; monitoring the control channel based on the information; and performing the SDT based on a result of the monitoring procedure. In this way, the terminal device may determine a set of resources for the PDCCH monitoring for the SDT and therefore the blocking probability in the common search space can be avoid and the system efficiency can be improved.

### FIELD

Embodiments of the present disclosure generally relate to the field of telecommunication and in particular to devices, methods, apparatuses and computer readable storage media of Physical Downlink Control Channel (PDCCH) monitoring for Small Data Transmission (SDT) procedure.

### BACKGROUND

5G New Radio (NR) is the 5th generation mobile network. It is a new global wireless standard after 1G, 2G, 3G, and 4G networks. 5G enables a new kind of network that is designed to connect virtually everyone and everything together including machines, objects, and devices. 5G wireless technology is meant to deliver higher multi-Gbps peak data speeds, ultra-low latency, more reliability, massive network capacity, increased availability, and a more uniform user experience to more users. Higher performance and improved efficiency empower new user experiences and connects new industries.

The NR will support sending multiple Uplink (UL)/Downlink (DL) packets during the SDT procedure while not transitioning the User Equipment (UE) into a RRC_CONNECTED state in between nor performing separate SDT procedures for those transmissions. The SDT procedure in a RRC_INACTIVE state can be achieved based on a Random Access Channel (RACH) procedure or configured grant (CG).

### SUMMARY

In general, example embodiments of the present disclosure provide a solution of PDCCH monitoring for SDT procedure.

In a first aspect, there is provided a first device. The first device comprises at least one processor; and at least one memory including computer program codes; the at least one memory and the computer program codes are configured to, with the at least one processor, cause the first device at least to receive, from a second device, information associated with a set of resources for monitoring a control channel between the first device and the second device for SDT procedure between the first device and the second device; monitor the control channel based on the information; and perform the SDT procedure based on a result of the monitoring procedure.

In a second aspect, there is provided a second device. The second device comprises at least one processor; and at least one memory including computer program codes; the at least one memory and the computer program codes are configured to, with the at least one processor, cause the second device at least to generate information associated with a set of resources for monitoring a control channel between the first device and the second device for a SDT procedure between the first device and the second device and transmit the information to the first device.

In a third aspect, there is provided a method. The method comprises receiving, from a second device, information associated with a set of resources for monitoring a control channel between the first device and the second device for a SDT procedure between the first device and the second device; monitoring the control channel based on the information; and performing the SDT procedure based on a result of the monitoring procedure.

In a fourth aspect, there is provided a method. The method comprises generating information associated with a set of resources for monitoring a control channel between the first device and the second device for a SDT procedure between the first device and the second device and transmitting the information to the first device.

In a fifth aspect, there is provided an apparatus comprising means for receiving, from a second device, information associated with a set of resources for monitoring a control channel between the first device and the second device for a SDT procedure between the first device and the second device; means for monitoring the control channel based on the information; and means for performing the SDT procedure based on a result of the monitoring procedure.

In a sixth aspect, there is provided an apparatus comprising means for generating information associated with a set of resources for monitoring a control channel between the first device and the second device for a SDT procedure between the first device and the second device and means for transmitting the information to the first device.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example communication network 100 in which example embodiments of the present disclosure can be implemented;

FIG. 2 shows a signaling chart illustrating a process of PDCCH monitoring for SDT procedure according to some example embodiments of the present disclosure;

FIG. 3 shows a flowchart of an example method of PDCCH monitoring for SDT procedure according to some example embodiments of the present disclosure;

FIG. 4 shows a flowchart of an example method of PDCCH monitoring for SDT procedure according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

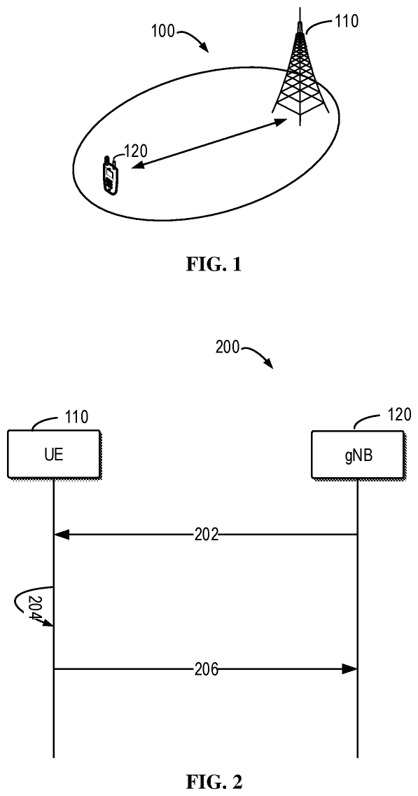

FIG. 1 shows an example communication network 100 in which embodiments of the present disclosure can be implemented. As shown in FIG. 1, the communication network 100 includes a terminal device 110 (hereinafter may also be referred to as a first device 110 or a UE 110. The communication network 100 may comprise a network device 120 (hereinafter may also be referred to as a second device 120 or a gNB 120). The network device 120 may communicate with the terminal device 110.

It is to be understood that the number of terminal devices and network devices are only for the purpose of illustration without suggesting any limitations. The communication network 100 may include any suitable number of terminal devices adapted for implementing embodiments of the present disclosure.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

The RRC_INACTIVE state can be supported by NR and the UE with infrequent data transmission are generally maintained by the network in the RRC_INACTIVE state. Conventionally, the data transmission cannot be performed in the RRC_INACTIVE state. That is, the UE has to resume the connection (i.e. move to RRC_CONNECTED state) for any DL and UL data. For each data transmission, no matter how small and infrequent the data packets are, the connection setup and subsequently release to INACTIVE state must be performed, which may results in unnecessary power consumption and signalling overhead.

Signalling overhead from INACTIVE state UEs for small data packets is a general problem. In general, any device that has intermittent small data packets in INACTIVE state will benefit from enabling small data transmission in INACTIVE state. Therefore, in order to improve network performance and efficiency and the UE battery performance,

It has been proposed that the SDT in the RRC_INACTIVE state can be supported in NR. The 2-step, 4-step RACH and configured grant type-1 have already been specified for achieving the data transmission in the RRC_INACTIVE state.

For RACH based SDT, upon successful completion of contention resolution, the UE shall monitor the Cell-Radio Network Temporary Identifier (C-RNTI). For CG based SDT, the configuration of configured grant resource for UE uplink small data transmission can be contained in the RRCRelease message. The Configuration is only type 1 CG with no contention resolution procedure for CG.

Furthermore, for both RACH based SDT and CG based SDT, when the UE is in RRC_INACTIVE state, it should be possible to send multiple UL and DL packets as part of the same SDT mechanism and without transitioning to RRC_CONNECTED on dedicated grant.

For the RACH based SDT, it is to be discussed the configuration of the Control Resource Set (CORESET) and Search Space (SS) for monitoring the PDCCH addressed to the C-RNTI after successful completion of the RA procedure during RA-SDT. For CG based SDT, it is to be discussed the configuration of association between the type 1 CG resource(s) for CG-SDT and Synchronization Signal Block(s) (SSB(s)).

The PDCCH in NR carries Downlink Control Information (DCI). The DCI contains the scheduling information for the UL or DL data channels and other control information for one UE or a group of UEs. For the DCI payload bits, a 24-bit cyclic redundancy check (CRC) is calculated and appended to the payload. The CRC allows the UE to detect the presence of errors in the decoded DCI payload bits. After the CRC is attached, the last 16 CRC bits are masked with a corresponding identifier, which may referred to as a radio network temporary identifier (RNTI). Using the RNTI mask, the UE can detect the DCI for its unicast data and distinguish sets of DCI with different purposes that have the same payload size.

The payload bits of each DCI are separately scrambled by a scrambling sequence generated from the length-31 Gold sequence. The scrambling sequence is initialized by the physical layer cell identity of the cell or by a UE specific scrambling identity and a UE specific C-RNTI. After the scrambled DCI bit sequence is Quadrature Phase Shift Keying (QPSK) modulated, the complex-valued modulation symbols are mapped to physical resources in units, which may be referred to as Control Channel Elements (CCEs).

Each CCE may consists of six Resource Element Groups (REGs), where a REG is defined as one Physical Resource Block (PRB) in one Orthogonal Frequency Division Multiplexing (OFDM) symbol which contains 9 Resource Elements (REs) for the PDCCH payload and 3 REs for Demodulation Reference Signal (DMRS). For each DCI, 1, 2, 4, 8, or 16 CCEs can be allocated, where the number of CCEs for a DCI is denoted as aggregation level (AL). Based on the channel environment and available resources, the gNB can adaptively choose a proper AL for a DCI to adjust the code rate.

A DCI with AL L can be mapped to physical resources in a given BandWidth Part (BWP), where necessary parameters such as frequency and time domain resources, and scrambling sequence identity for the DMRS for the PDCCH can be configured to a UE by means of CORESET. A UE may be configured with up to 3 CORESETs in Release 15 and up to 5 CORESETs in Release 16 on each of up to 4 BWPs on a serving cell.

The UE can perform blind decoding for a set of PDCCH candidates. The PDCCH candidates to be monitored are configured for a UE by means of SS sets. There are two SS set types, namely the common SS (CSS) set, which is commonly monitored by a group of UEs in a cell, and the UE-specific SS (USS) set, which is monitored by an individual UE.

A UE can be configured with up to 10 SS sets each for up to four BWPs in a serving cell. In general, the SS set configuration provides a UE with the SS set type, DCI format(s) to be monitored, monitoring occasion (periodicity, slot offset, duration in terms of successive slots), and the number of PDCCH candidates for each AL in the SS set.

The mapping of PDCCH candidates of an SS set to CCEs of the associated CORESET is implemented by means of a hash function. The hash function randomizes the allocation of the PDCCH candidates within CORESET. However, the hash function is not applied for any CSS set. That means that CCEs of PDCCHs are mapped to the same set of CCEs and thus they may block each other.

In this situation, when the first SDT transmission is performed, e.g., over 2-step or 4-step RACH, more data packets may come into UE's or network's buffer. The CSS and CORESET #0 will be generally used for network scheduling UE after the contention resolution. However, when UEs performing SDT have subsequent SDT data, scheduling such data may load the CSS/CORESET #0 such that less UEs can be served by the network. In other words, the same set of CCEs within the CORESET would need to be shared among CCS sets and SDT UEs. Consequence is the increased blocking probability which may be significant given high number of SDT UEs served.

The present disclosure provides solutions of PDCCH monitoring for SDT. In this solution. In this solution, the terminal device can obtain, from the network device, information associated with a PDCCH monitoring for the SDT between the terminal device and the network device. The terminal device then may monitor the PDCCH based on the information and perform the SDT based on a result of the PDCCH monitoring. In this way, the terminal device may determine a set of resources for the PDCCH monitoring for the SDT and therefore the blocking probability in the common search space can be avoid and the system efficiency can be improved.

Principle and implementations of the present disclosure will be described in detail as below with reference to FIG. 2, which shows a schematic process of PDCCH monitoring for SDT. For the purpose of discussion, the process 200 will be described with reference to FIG. 1. The process 200 may involve the UE 110 and the gNB 120 as illustrated in FIG. 1.

As shown in FIG. 2, the UE 110 may receive 202, from the gNB 120, information associated with a set of resources for monitoring a PDCCH between the UE 110 and the gNB 120 for a SDT procedure between the UE 110 and the gNB 120.

In some example embodiments, the information can comprise a C-RNTI obtained from a RA procedure initiated for the SDT procedure. For example, in a RA procedure, the UE 110 may transmit a Message1 (MSG1) with a random access preamble to the gNB 120. After receiving the MSG1 from the UE 110, the gNB 120 may generate a random access response including a temporary-CRNTI (T-CRNTI) and transmit the random access response to the UE 110 as the Message2. After the contention solution is completed in the RA procedure, the T-CRNTI can be considered as the C-RNTI and used for scrambling the PDCCH in Message 4

In some example embodiments, the information can comprise a C-RNTI or other RNTI (e.g. SDT-RNTI) obtained from Configure Grant configuration allocated by the gNB 120.

In some example embodiments, the UE 110 may determine the set of resources for monitoring a PDCCH between the UE 110 and the gNB 120 for the SDT procedure based on the C-RNTI.

When the UE is in a RRC_INACTIVE state, the UE may monitor the PDCCH in CSS sets for transmitting the small data packet. For example, the UE may determine mapping between the PDCCH of the CSS and the corresponding CCEs in a CORESET allowed to be used for monitoring the PDCCH based on the C-RNTI. For example, when the C-RNTI is obtained, the C-RNTI can be used for a hash operation for mapping the PDCCH of the CSS provided PDCCH monitoring for subsequent UL and/or DL SDT transmissions to the corresponding CCEs in the CORESET.

In some example embodiments, the UE 110 may determine, based on the C-RNTI, the set of resources for monitoring a PDCCH for the SDT procedure from a set of candidate resources allowed to be used for monitoring the PDCCH.

In some example embodiments, the set of resources can be considered as a SDT specific CSS set (e.g. Type4-PDCCH) which is associated to CORESET #0 and the UE can provided with such SDT specific CSS set. In some example embodiments, if the Type4-PDCCH is not provided to the UE, the UE may apply Type0-PDCCH CSS.

In some example embodiments, the UE 110 can also determine, based on the C-RNTI, the set of resources for monitoring a PDCCH for the SDT procedure on a new BWP which is different from an initial BWP. For example, the initial BWP can be a BWP on which the RA procedure is initiated. After completion of the SDT procedure, the CORESET/SS for the SDT procedure can be released and the UE can move back to original BWP.

In some example embodiments, it is also possible that the information comprises an explicit indication of the set of resources for monitoring a PDCCH between the UE 110 and the gNB 120 for the SDT procedure. The UE 110 may obtain the set of resources for monitoring a PDCCH for the SDT procedure from the indication.

After the set of resources for monitoring a PDCCH for the SDT procedure is determined based on the C-RNTI or an explicit indication, the UE 110 may monitor 204 the PDCCH on the set of resources.

In some example embodiments, the UE 110 can use the set of resources for monitoring a PDCCH for the SDT procedure upon completion of the RA procedure for SDT procedure, i.e., upon successful contention resolution and the RA procedure completion.

In some example embodiments, the UE 110 can also use the set of resources for monitoring a PDCCH for the SDT procedure during the RA procedure.

In some example embodiments, the UE 110 can also decode the set of candidate resources allowed to be used for monitoring the PDCCH, for example, the CSS/CORESET #0, if the set of candidate resources are within the same BWP as the SS/CORESET for SDT procedure. The corresponding priority can be configured for different resource sets. For example, in some example embodiments, the CSS/CORESET #0 may be prioritized over SS/CORESET for the SDT procedure. In some example embodiments, the SS/CORESET for the SDT procedure can be prioritized over CSS/CORESET #0.

After monitoring the PDCCH on the set of resources, the UE may detect the DCI from the resource and obtain UL grant for the SDT procedure and transmit 206 the small data packet on the UL grant in a RRC_INACTIVE state.

In this way, the terminal device may determine a set of resources for the PDCCH monitoring for the SDT procedure and therefore the blocking probability in the common search space can be avoid and the system efficiency can be improved.

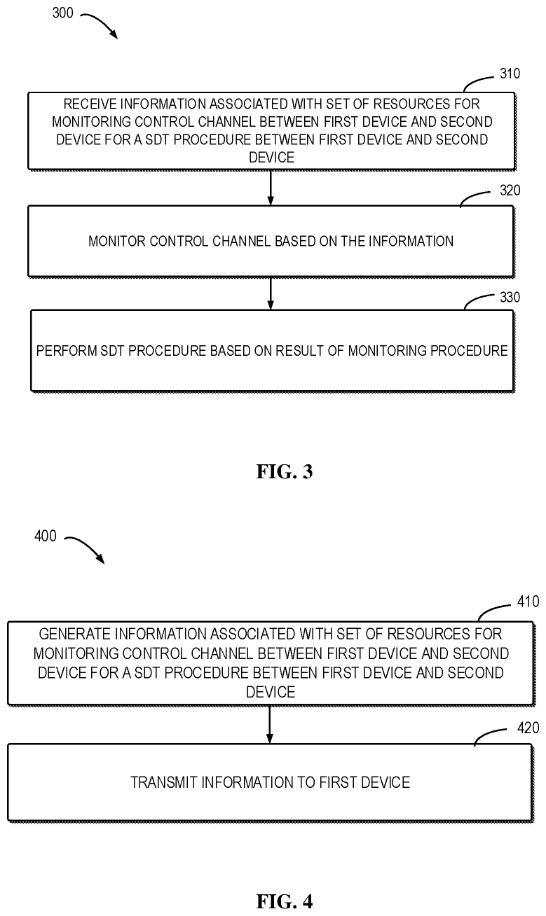

FIG. 3 shows a flowchart of an example method 300 of PDCCH monitoring for SDT procedure according to some example embodiments of the present disclosure. The method 300 can be implemented at the first device 110 as shown in FIG. 1. For the purpose of discussion, the method 300 will be described with reference to FIG. 1.

At 310, the first device receives, from a second device, information associated with a set of resources for monitoring a control channel between the first device and the second device for a SDT procedure between the first device and the second device.

In some example embodiments, the information can comprise a C-RNTI.

In some example embodiments, the information includes an indication of the set of resources for monitoring the control channel for the SDT procedure.

At 320, the first device monitors the control channel based on the information.

In some example embodiments, the first device may obtain a C-RNTI from the information, the C-RNTI being allocated by the second device. The first device may further determine, based on the C-RNTI, the set of resources for monitoring the control channel for the SDT procedure from a set of candidate resources allowed to be used for monitoring the control channel and monitor the control channel on the set of resources.

In some example embodiments, the first device may obtain a C-RNTI from the information, the C-RNTI being allocated by the second device. The first device may further determine, based on the C-RNTI, the set of resources for monitoring the control channel for the SDT procedure on a new bandwidth part different than an initial bandwidth part and monitor the control channel on the set of resources.

In some example embodiments, the first device may obtain the C-RNTI from a RA procedure initiated for the SDT procedure or a configure grant allocated by the second device.

In some example embodiments, the set of resources may comprise a dedicated search space for monitoring the control channel for the SDT procedure or a common search space for monitoring the control channel for the SDT procedure.

In some example embodiments, the first device may monitor the control channel on the set of resources for monitoring the control channel for the SDT procedure after the RA procedure is completed.

In some example embodiments, the first device may monitor the control channel on the set of resources for monitoring the control channel for the SDT procedure during the RA procedure.

In some example embodiments, the first device may monitor the control channel on the set of candidate resources allowed to be used for monitoring the control channel, the set of candidate resources having a different priority from the set of resources.

In some example embodiments, the first device may obtain an indication of a set of resources for monitoring the control channel for the SDT procedure from the information and monitor the control channel on the set of resources.

At 330, the first device performs the SDT procedure based on a result of the monitoring procedure.

In some example embodiments, the first device comprises a terminal device and the second device comprises a network device.

FIG. 4 shows a flowchart of an example method 400 of PDCCH monitoring for SDT procedure according to some example embodiments of the present disclosure. The method 400 can be implemented at the second device 120 as shown in FIG. 1. For the purpose of discussion, the method 400 will be described with reference to FIG. 1.

At 410, the second device generates information associated with a set of resources for monitoring a control channel between the first device and the second device for a SDT procedure between the first device and the second device.

In some example embodiments, the information can comprise a C-RNTI.

In some example embodiments, the information includes an indication of the set of resources for monitoring the control channel for the SDT procedure.

At 420, the second device transmits the information to the first device.

In some example embodiments, the first device comprises a terminal device and the second device comprises a network device.

In some example embodiments, an apparatus capable of performing the method 300 (for example, implemented at the first device 110) may comprise means for performing the respective steps of the method 300. The means may be implemented in any suitable form. For example, the means may be implemented in a circuitry or software module.

In some example embodiments, the apparatus comprises means for receiving, from a second device, information associated with a set of resources for monitoring a control channel between the first device and the second device for a SDT procedure between the first device and the second device; means for monitoring the control channel based on the information; and means for performing the SDT procedure based on a result of the monitoring procedure.

In some example embodiments, the information can comprise a C-RNTI.

In some example embodiments, the information includes an indication of the set of resources for monitoring the control channel for the SDT procedure.

In some example embodiments, the means for monitoring the control channel comprises means for obtaining a C-RNTI from the information, the C-RNTI being allocated by the second device, means for determining, based on the C-RNTI, the set of resources for monitoring the control channel for the SDT procedure from a set of candidate resources allowed to be used for monitoring the control channel for the SDT procedure and means for monitoring the control channel on the set of resources for monitoring the control channel for the SDT procedure.

In some example embodiments, the means for monitoring the control channel comprises means for obtaining a C-RNTI from the information, the C-RNTI being allocated by the second device, means for determining, based on the C-RNTI, the set of resources for monitoring the control channel for the SDT procedure on a new bandwidth part different than an initial bandwidth part and means for monitoring the control channel on the set of resources for monitoring the control channel for the SDT procedure.

In some example embodiments, the means for obtaining the C-RNTI comprises means for obtaining the C-RNTI from a RA procedure initiated for the SDT procedure or a configure grant allocated by the second device.

In some example embodiments, the set of resources may comprise a dedicated search space for monitoring the control channel for the SDT procedure or a common search space for monitoring the control channel for the SDT procedure.

In some example embodiments, the means for monitoring the control channel on the set of resources for monitoring the control channel for the SDT procedure comprises means for monitoring the control channel on the set of resources for monitoring the control channel for the SDT procedure after the RA procedure is completed.

In some example embodiments, the means for monitoring the control channel on the set of resources for monitoring the control channel for the SDT procedure comprises means for monitoring the control channel on the set of resources for monitoring the control channel for the SDT procedure during the RA procedure.

In some example embodiments, the apparatus also comprises means for monitoring the control channel on the set of candidate resources allowed to be used for monitoring the control channel, the set of candidate resources having a different priority from the set of resources.

In some example embodiments, the means for monitoring the control channel comprises means for obtaining an indication of a set of resources for monitoring the control channel for the SDT procedure from the information and means for monitoring the control channel on the set of resources.

In some example embodiments, the first device comprises a terminal device and the second device comprises a network device.

In some example embodiments, an apparatus capable of performing the method 400 (for example, implemented at the second device 120) may comprise means for performing the respective steps of the method 400. The means may be implemented in any suitable form. For example, the means may be implemented in a circuitry or software module.

In some example embodiments, the apparatus comprises means for generating information associated with a set of resources for monitoring a control channel between the first device and the second device for a SDT procedure between the first device and the second device and means for transmitting the information to the first device.

In some example embodiments, the information can comprise a C-RNTI.

In some example embodiments, the information includes an indication of the set of resources for monitoring the control channel for the SDT procedure.

In some example embodiments, the first device comprises a terminal device and the second device comprises a network device.

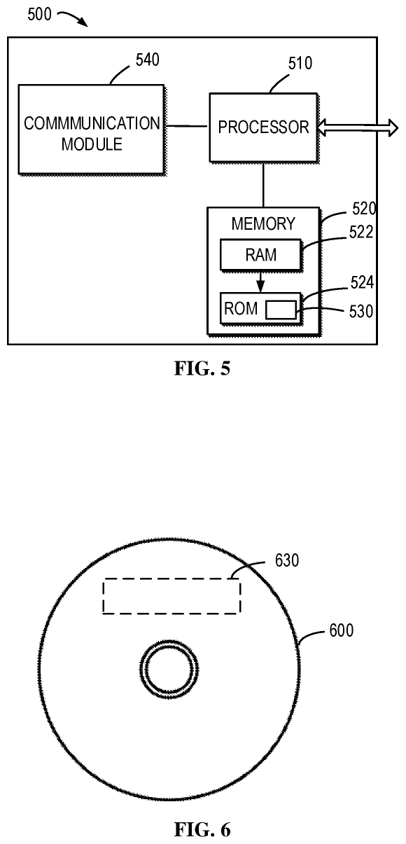

FIG. 5 is a simplified block diagram of a device 500 that is suitable for implementing embodiments of the present disclosure. The device 500 may be provided to implement the communication device, for example the UE 110 or the gNB 120 as shown in FIG. 1. As shown, the device 500 includes one or more processors 510, one or more memories 520 coupled to the processor 510, and one or more transmitters and receivers (TX/RX) 540 coupled to the processor 510.

The TX/RX 540 is for bidirectional communications. The TX/RX 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 520. The processor 510 may perform any suitable actions and processing by loading the program 530 into the RAM 520.

The embodiments of the present disclosure may be implemented by means of the program 530 so that the device 500 may perform any process of the disclosure as discussed with reference to FIGS. 2-4. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300 and 400 as described above with reference to FIGS. 3-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-36. (canceled)

37. A first device comprising:
at least one processor; and
at least one memory including computer program codes;
the at least one memory and the computer program codes are configured to, with the at least one processor, cause the first device at least to:
receive, from a second device, information associated with a set of resources for monitoring a control channel between the first device and the second device for a Small Data Transmission, SDT, procedure between the first device and the second device;
monitor the control channel based on the information; and
perform the SDT procedure based on a result of the monitoring procedure.

38. The first device of claim 37, wherein the information comprises a Cell-Radio Network Temporary Identifier, C-RNTI.

39. The first device of claim 37, wherein the information includes an indication of the set of resources for monitoring the control channel for the SDT procedure.

40. The first device of claim 37, wherein the first device is caused to monitor the control channel by:
obtaining a Cell-Radio Network Temporary Identifier, C-RNTI, from the information, the C-RNTI being allocated by the second device;
determining, based on the C-RNTI, the set of resources for monitoring the control channel for the SDT procedure from a set of candidate resources allowed to be used for monitoring the control channel; and
monitoring the control channel on the set of resources.

41. The first device of claim 37, wherein the first device is caused to monitor the control channel by:
obtaining a Cell-Radio Network Temporary Identifier, C-RNTI, from the information, the C-RNTI being allocated by the second device;
determining, based on the C-RNTI, the set of resources for monitoring the control channel for the SDT procedure on a new bandwidth part different than an initial bandwidth part of the first device; and
monitoring the control channel on the set of resource.

42. The first device of claim 40, wherein the first device is caused to obtain the C-RNTI by:
obtaining the C-RNTI from at least one of the following:
a Random Access, RA, procedure initiated for the SDT procedure, or
a configured grant configuration allocated by the second device.

43. The first device of claim 37, wherein the set of resources comprises at least one of the following:
a dedicated search space for monitoring the control channel for the SDT procedure, or
a common search space for monitoring the control channel for the SDT procedure.

44. The first device of claim 40, wherein the first device is caused to monitor the control channel on the set of resources by:
monitoring the control channel on the set of resources for monitoring the control channel for the SDT procedure after a Random Access, RA, procedure is completed.

45. The first device of claim 40, wherein the first device is caused to monitor the control channel on the set of resources by:
monitoring the control channel on the set of resources for monitoring the control channel for the SDT procedure during a Random Access, RA, procedure.

46. The first device of claim 40, wherein the first device is further caused to:
monitoring the control channel on the set of candidate resources allowed to be used for monitoring the control channel, the set of candidate resources having a different priority from the set of resources.

47. The first device of claim 37, wherein the first device is caused to monitor the control channel by:
obtaining an indication of a set of resources for monitoring the control channel for the SDT procedure from the information; and
monitoring the control channel on the set of resources.

48. The first device of claim 37, wherein the first device comprises a terminal device and the second device comprises a network device.

49. A second device comprising:
at least one processor; and
at least one memory including computer program codes;
the at least one memory and the computer program codes are configured to, with the at least one processor, cause the second device at least to:
generate information associated with a set of resources for monitoring a control channel between the first device and the second device for a Small Data Transmission, SDT, procedure between the first device and the second device; and
transmit the information to the first device.

50. The second device of claim 49, wherein the information comprises a Cell-Radio Network Temporary Identifier, C-RNTI.

51. The second device of claim 49, wherein the information includes an indication of the set of resources for monitoring the control channel for the SDT procedure.

52. The second device of claim 49, wherein the first device comprises a terminal device and the second device comprises a network device.

53. A method comprising:
receiving, from a second device, information associated with a set of resources for monitoring a control channel between the first device and the second device for a Small Data Transmission, SDT, procedure between the first device and the second device;
monitoring the control channel based on the information; and
performing the SDT procedure based on a result of the monitoring procedure.

54. The method of claim 53, wherein monitoring the control channel comprises:
obtaining a Cell-Radio Network Temporary Identifier, C-RNTI, from the information, the C-RNTI being allocated by the second device;
determining, based on the C-RNTI, the set of resources for monitoring the control channel for the SDT procedure on a new bandwidth part different than an initial bandwidth part of the first device; and
monitoring the control channel on the set of resources for monitoring the control channel for the SDT procedure.

55. The method of claim 54, wherein monitoring the control channel on the set of resources for monitoring the control channel for the SDT procedure comprises:
monitoring the control channel on the set of resources for monitoring the control channel for the SDT procedure during the RA procedure.

56. A non-transitory computer readable medium comprising program instructions for causing an apparatus to perform at least the method of any of claim 55.
